(19) United States
(12) Patent Application Publication
(10) Pub. No.: US 2025/0306277 A1
(43) Pub. Date: Oct. 2, 2025

(54) SELF-ASSEMBLED NANOPARTICLE MICROMIRRORS FOR OFF-CHIP OPTICAL COUPLING TO WAVEGUIDES

(71) Applicant: The Charles Stark Draper Laboratory, Inc., Cambridge, MA (US)

(72) Inventors: David Carter, Cambridge, MA (US); Sarah Geiger, Cambridge, MA (US); Diana Lewis, Cambridge, MA (US); Daniel Vresilovic, Cambridge, MA (US)

(21) Appl. No.: 19/092,184

(22) Filed: Mar. 27, 2025

Related U.S. Application Data
(60) Provisional application No. 63/570,374, filed on Mar. 27, 2024.

(51) Int. Cl. G02B 6/13; G02B 6/136

(52) U.S. Cl. CPC G02B 6/131; G02B 6/136

(57) ABSTRACT

A method for fabricating a waveguide chip may include applying at least one higher refractive index material to a portion of a dielectric material, the dielectric material having a first portion and a second portion, the second portion having a higher profile than the first portion and the higher refractive index material being applied to the second portion; and presenting a light beam via the higher refractive index material to self-assembled crystal grown on a growth plane on the first portion of the oxide via the higher refractive index material arranged above the growth plane on the second portion of the dielectric material.

### CROSS-REFERENCED TO RELATED APPLICATION

This application claims the benefit of U.S. provisional application Ser. No. 63/570,374 filed Mar. 27, 2024, the disclosure of which is hereby incorporated in its entirety by reference herein.

### STATEMENT REGARDING FEDERALLY SPONSORED RESEARCH OR DEVELOPMENT

This invention was made with Government support under Contract No. N00014-19-1-2213, awarded by the Department of the Navy, Office of Naval Research. The Government has certain rights in the invention.

### TECHNICAL FIELD

Disclosed herein are systems and methods for self-assembled nanoparticle micromirrors for off-chip optical coupling to waveguide.

### BACKGROUND

Photonic integrated circuits (PICs) are typically fabricated with lithography on chips made of silicon or silica. These circuits may replace electronic integrated circuits in some applications, having the benefit of decreased on-chip area and fasters speeds.

### SUMMARY

A method for fabricating a waveguide chip may include applying at least one higher refractive index material to a portion of a dielectric material, the dielectric material having a first portion and a second portion, the second portion having a higher profile than the first portion and the higher refractive index material being applied to the second portion; and presenting a light beam via the higher refractive index material to self-assembled crystal grown on a growth plane on the first portion of the oxide via the higher refractive index material arranged above the growth plane on the second portion of the dielectric material.

A method for fabricating a waveguide chip may include applying at least one higher refractive index material to a portion of a dielectric material, the dielectric material having a first portion and a second portion, the second portion having a higher profile than the first portion and the higher refractive index material being applied to the second portion, applying a growth attachment layer to the first portion of the dielectric material and adjacent to the higher refractive index material to create a growth plane, and applying photoresists to a portion of the growth attachment layer, dielectric material and higher refractive index material to facilitate crystal growth on the growth plane, the growth area not including the photoresists, wherein the higher refractive index material is arranged elevated relative to the growth attachment layer and configured to present a light beam to the crystal during use.

A waveguide chip may include a substrate, an oxide arranged on the substrate having a first portion adjacent to a second portion, the first portion having a higher profile than the second portion creating an offset between the first portion and the second portion, a waveguide arranged on the second portion of the oxide, and a self-assembled crystal structure arranged on the first portion of the oxide configured to receive a beam from the waveguide arranged on the second portion of the oxide.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 illustrates a top view of a photonic integrated circuit device;

FIG. 2 illustrates a side view of the photonic integrated circuit device;

FIG. 3 illustrates a top view of the photonic integrated circuit device;

FIG. 4 illustrates a side view of the photonic integrated circuit device;

FIG. 5 illustrates an example pyramid structure with relevant angles of reflection of the self-assembled nanoparticle structure;

FIG. 6A illustrates a side view of an example finite difference time domain (FDTD) model of a photonic integrated circuit device without the pyramid nanoparticle structure;

FIG. 6B illustrates a top view of the FDTD model a photonic integrated circuit device without the pyramid nanoparticle structure;

FIG. 7A illustrates a side view of an example FDTD model of a photonic integrated circuit device of FIGS. 1 and 2 having the pyramid nanoparticle structure;

FIG. 7B illustrates a top view of the FDTD model a photonic integrated circuit device of FIGS. 1 and 2 having the pyramid nanoparticle structure;

FIG. 8 illustrates an example far field FDTD model of the photonic integrated circuit device with the pyramid nanoparticle structure;

FIG. 9 illustrates an example FDTD model at a top view of the pyramid;

FIG. 10 illustrates an example transmission chart of the transmission vs. wavelength (nm);

FIG. 11 illustrates a chart of a beam radius (um) vs. distance from the waveguide (um) for an 800 nm wavelength; and

FIGS. 12A-N illustrates side views of a process for assembly of the photonic integrated circuit device.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

As Photonic Integrated Circuits (PICs) demonstrate the capacity to replace electronic integrated circuits in some applications, with the benefits of decreased on-chip area and faster speeds, developing the photonic version of a ‘wire-bond’ to create photonic chip-to-chip interconnects with low signal loss becomes one of the limiting factors towards the maturity and ease of integration of PICs into commercial devices. Fiber-to-chip bonding and direct-write 3D-printed polymer waveguides have been developed to bridge PICs, however these methods are expensive and have low-throughput. Compressive interconnects have also been contemplated, however the physical connection between chips may have an extremely tight alignment tolerance and requires a high-class cleanroom environment for assembly, as the presence of particles can severely impede coupling. Therefore free-space coupling is a mechanically favorable method of getting a signal from chip to chip.

Compared to grating-based couplers, which couple light from free space into optical waveguides on a substrate, mirrors offer higher bandwidth, which can have significant positive impact on system performance. Existing methods of mirror fabrication (e.g., focused-ion-beam milling or grayscale lithography) are not easily scalable or common in manufacturing. Self-assembled mirrors integrated with waveguides could offer highly scalable, highly efficient couplers.

Self-assembled systems may use DNA-Nanoparticle (DNA-NP) arrays. DNA may allow for independently tailored interactions between various nanoscale elements. With certain design rules, crystallization techniques are available allowing for a high degree of predictability in lattice formation, making this process one of the most programmable crystallization techniques available for synthesizing nanostructured materials. The lattices may be embedded into or stabilized by other materials post-assembly, including silica. Once stabilized in these inorganic materials, the DNA-programmed lattices are rendered mechanically and chemically stable to a wide variety of conditions. The particle arrays can be subjected to high temperatures (>300° C.), various chemical solvents and solvent removal, vacuum, and even high energy X-ray radiation without any noticeable change to the positions of individual particles within the lattice. Self-assembled metamaterials may also be used on substrates to enable certain optical properties. Certain metamaterials offer specific properties, such as negative refractive index, perfect absorption or perfect retro-reflection, etc.

With known crystal habits, the process has led to the formation of lattices with well-defined microscale structures, specifically polyhedral shapes that are dictated as a function of the crystallographic symmetry of the DNA-NP lattice. The ability to make materials that have programmable structure at the nano and microscale paves the way for the formation of both device architectures and unique studies into the optical, chemical, and mechanical properties of these materials, providing significant promise for the development of unprecedented metamaterials with unique physical characteristics.

Disclosed herein is a system and method for incorporating self-assembled mirrors or crystals into a waveguide chip fabrication process. Particularly, coupling structures (possibly made of polymers) are implemented to couple to fiber modes to match the mode of the waveguide with the size of the mirror. Such coupling structures may use larger SU-8 waveguides which couple to smaller waveguides, such as those used as couplers for fibers. This results in a smaller numerical aperture and lower angle of expansion allowing for a majority of light to hit the mirror, resulting in lower losses. Further, recessing the crystal growth plane lower than the waveguide to allow the expanded light beam to hit the crystal facet and instead of a substrate allows for more reflection. This may also be aided by an added oxide etch to enable the grown plane for the crystal and waveguide. The method includes accounting for lithographic alignment tolerances, and may incorporate a gold pad near the waveguide to enable crystal growth for the self-assembled mirrors. An array of crystals may be incorporated, where one is placed in front of the waveguide and used for signal coupling. The other crystals, while not used optically, may be placed to ensure optimal growth of the active crystal.

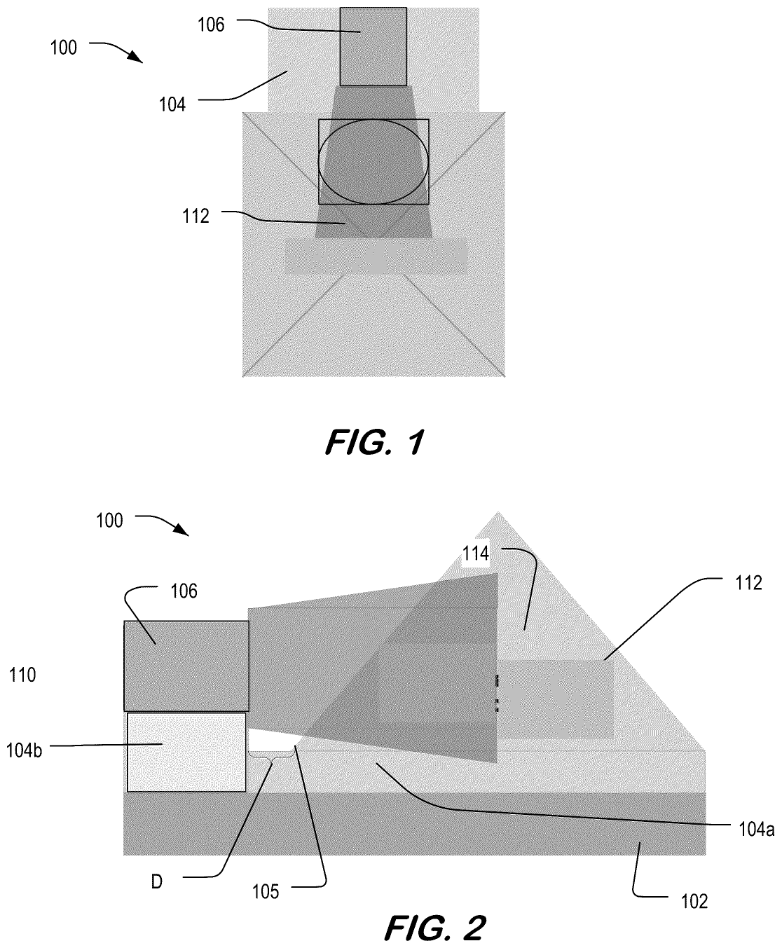

FIG. 1 illustrates a top view of a photonic integrated circuit device 100 and FIG. 2 illustrates a side view of the photonic integrated circuit device 100. The photonic component may utilize photons for transferring information and may allow for faster and more energy efficient devices. The device 100 may include a substrate 102 and a low-loss optical dielectric cladding material such as an oxide 104. In this example the oxide 104 may be silicon dioxide, SiO₂. However, other oxides may be contemplated such as hafnium dioxide HfO₂, aluminum oxide Al₂O₂, etc.

The oxide 104 may include a first portion 104a and a second portion 104b adjacent the first portion 104a, the second portion 104b having a higher profile than the first portion 104a in a first plane and creating a step 110. The step 110 creates an offset in the first plane between the first portion 104a and the second portion 104b, as best illustrated in the side view of FIG. 2.

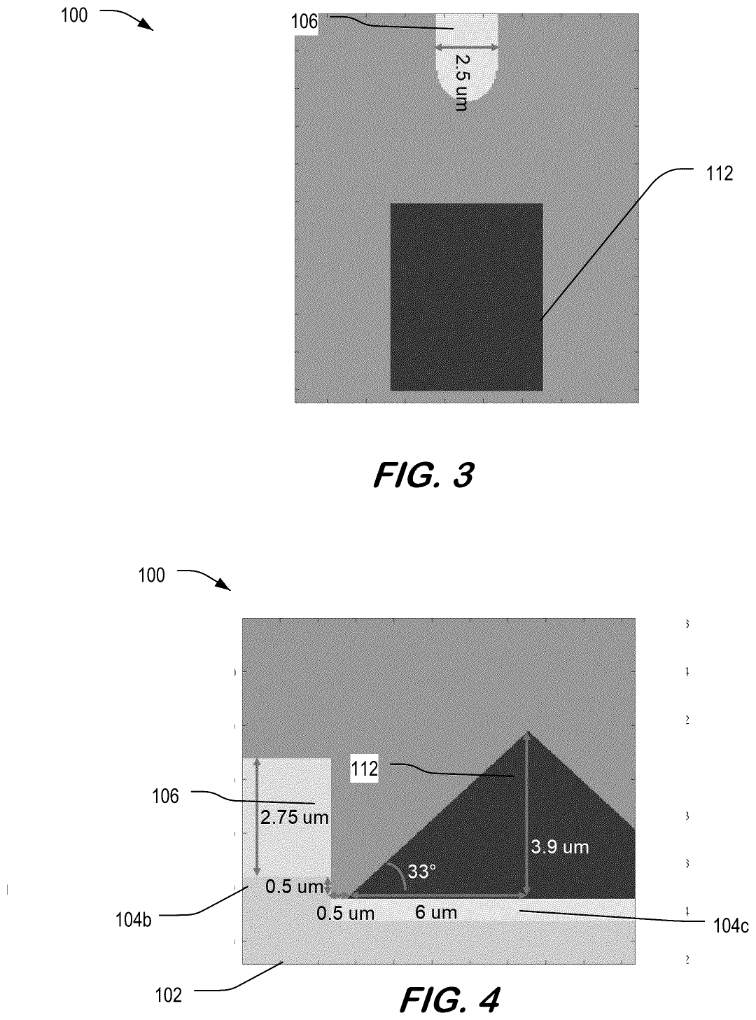

A material, potentially a polymer such as SU-8, may be patterned into a waveguide 106, and may be arranged on the oxide 104, and specifically on the second portion 104b to guide light 114 towards the first portion 104a. Other materials such as polymethyl methacrylate (PMMA), parylene, polyimide, benzocyclobutene, etc., may also be contemplated. The waveguide 106 is a low-loss, higher refractive index material, that allows light to pass therethrough. A self-assembled nanoparticle structure 112 is arranged on the first portion 104a and is configured to receive the light 114 from waveguide 106. The self-assembled nanoparticle structure 112 may be grown on a growth attachment layer, such as a metal layer, for example gold (not labeled in FIGS. 1 and 2, 104c in FIG. 4) to create a growth plane. In one example, the self-assembled nanoparticle structure 112 may be approximately 10 um×10 um and may form a pyramid-like shape. An edge 105 of the structure 112 may be spaced, in one example, approximately 0.5 um from the edge 105 of the second portion 104b of the oxide 104. Specific dimensions, which are illustrated further in FIGS. 3 and 4, are exemplary and other dimensions may be contemplated. For example, the dimensions may be 1-5 um. Such predefined distance DI is labeled in FIG. 2, but also visible in at least FIGS. 1, 3 and 4. FIG. 3 illustrates a top view of the photonic integrated circuit device 100 and FIG. 4 illustrates a side view of the photonic integrated circuit device 100.

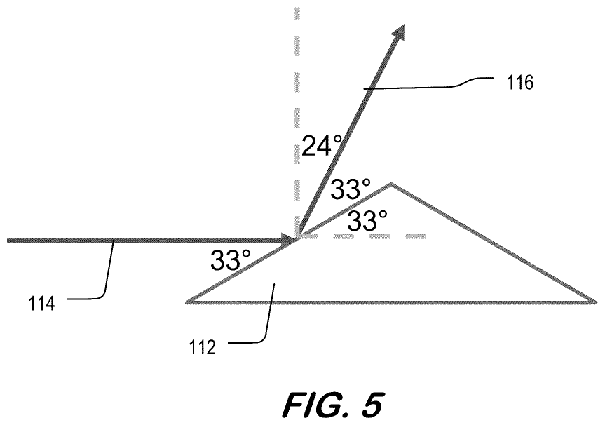

FIG. 5 illustrates an example pyramid structure with relevant angles of reflection of the light 114 from the self-assembled nanoparticle structure 112. The structure 112 may be formed of example angles and provide for example reflection angles, as illustrated. In the example shown, a reflected beam 116 may be emitted at an angle of 24 degrees from vertical when the structure 112 is formed using a 33 degree acute angle.

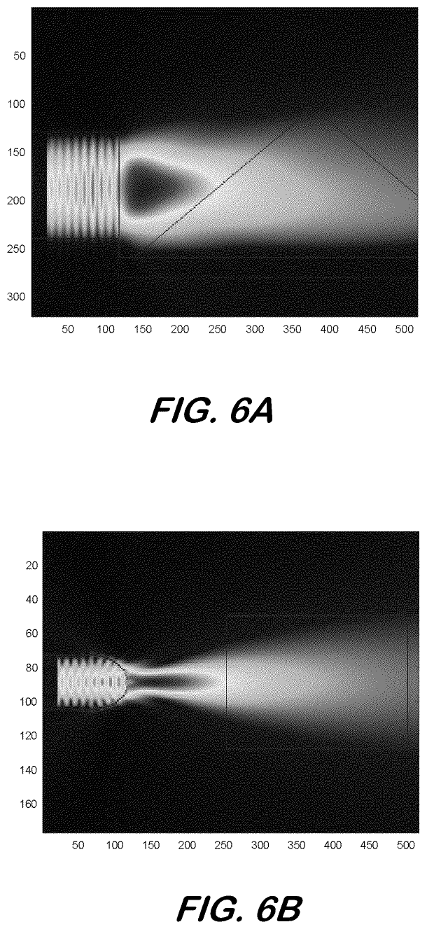

FIG. 6A illustrates a side view of an example finite difference time domain (FDTD) model of a photonic integrated circuit device without the pyramid nanoparticle structure 112 (although the outline of a structure is shown, it is not present in the model). FIG. 6B illustrates a top view of the FDTD model a photonic integrated circuit device without the pyramid nanoparticle structure 112.

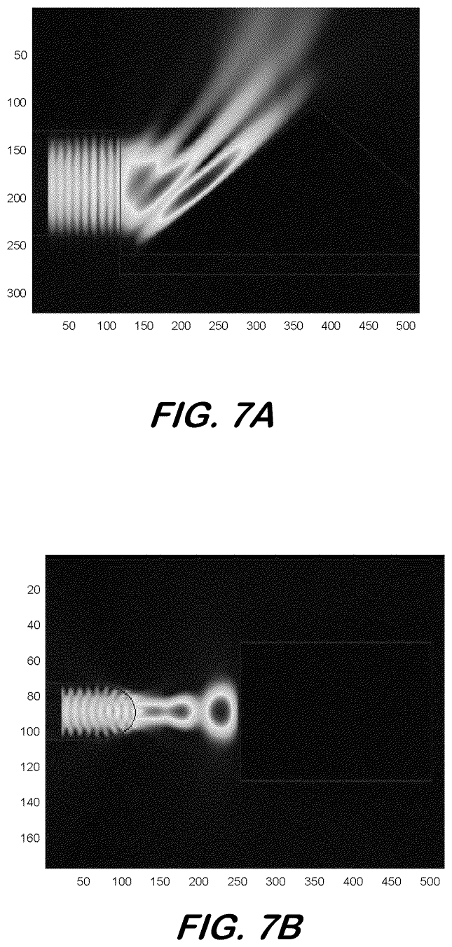

FIG. 7A illustrates a side view of an example FDTD model of a photonic integrated circuit device of FIGS. 1 and 2 having the pyramid nanoparticle structure 112. FIG. 7B illustrates a top view of the FDTD model a photonic integrated circuit device 100 of FIGS. 1 and 2 having the pyramid nanoparticle structure 112.

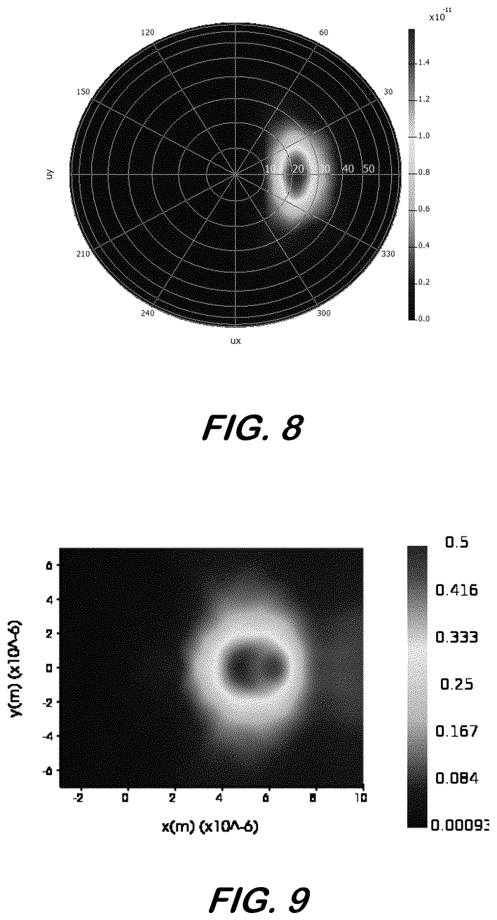

FIG. 8 illustrates an example far-field FDTD model of the photonic integrated circuit device 100 with the pyramid nanoparticle structure 112.

FIG. 9 illustrates an example FDTD model at a top view of the pyramid 112.

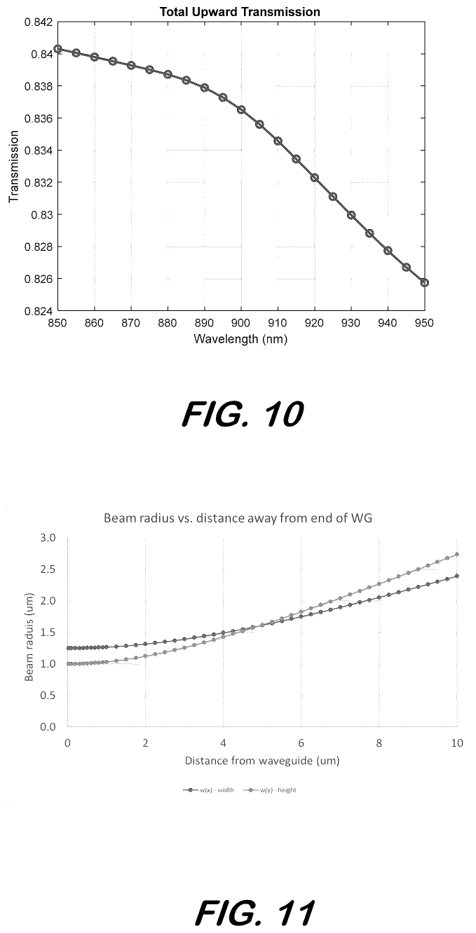

FIG. 10 illustrates an example simulated chart of the transmission vs. wave length (nm).

FIG. 11 illustrates a chart of a beam radius (um) vs. distance from the waveguide 106 for an 800 nm wavelength. The growth plane (e.g., gold 104c) may be spaced a predefined distance relative to the higher refractive index material (e.g., waveguide 106).

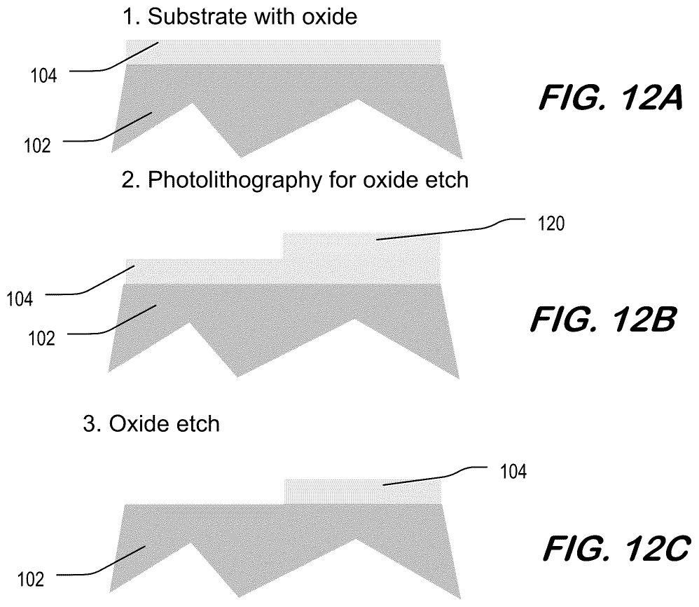

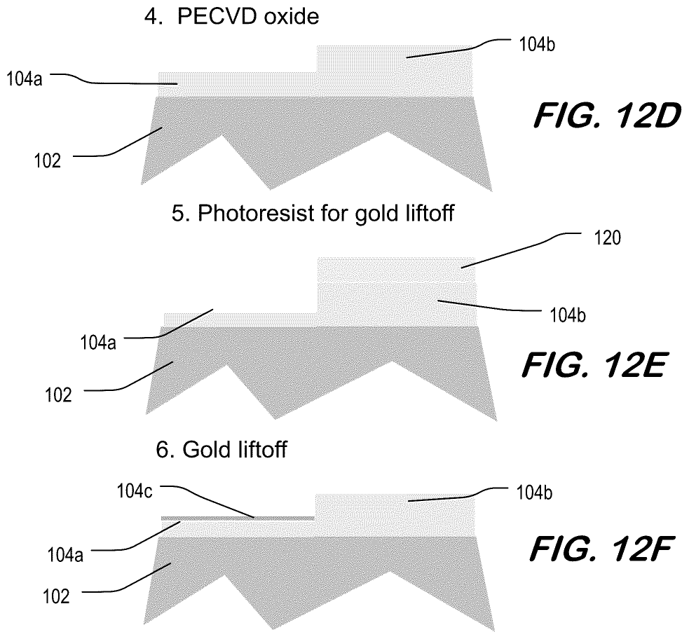

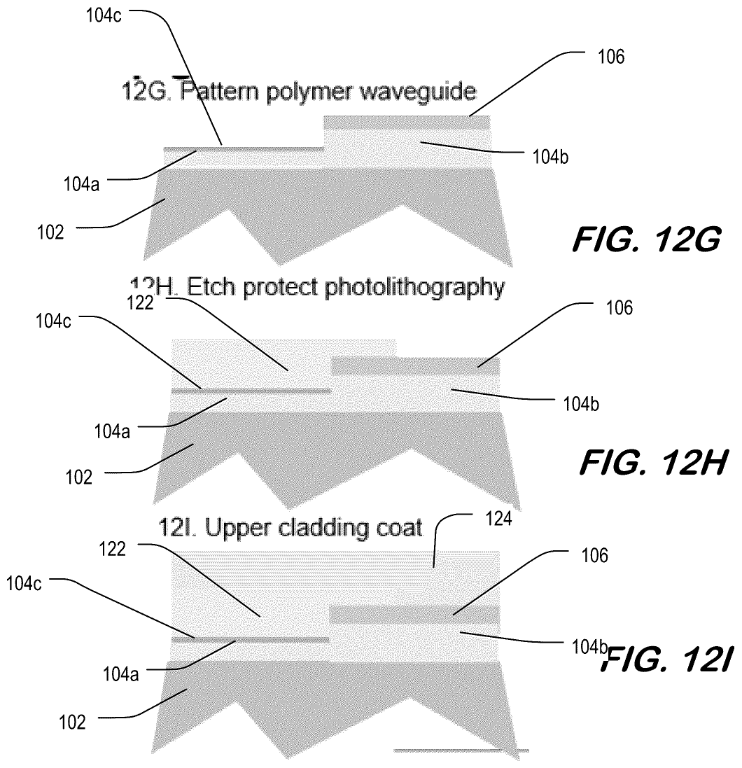

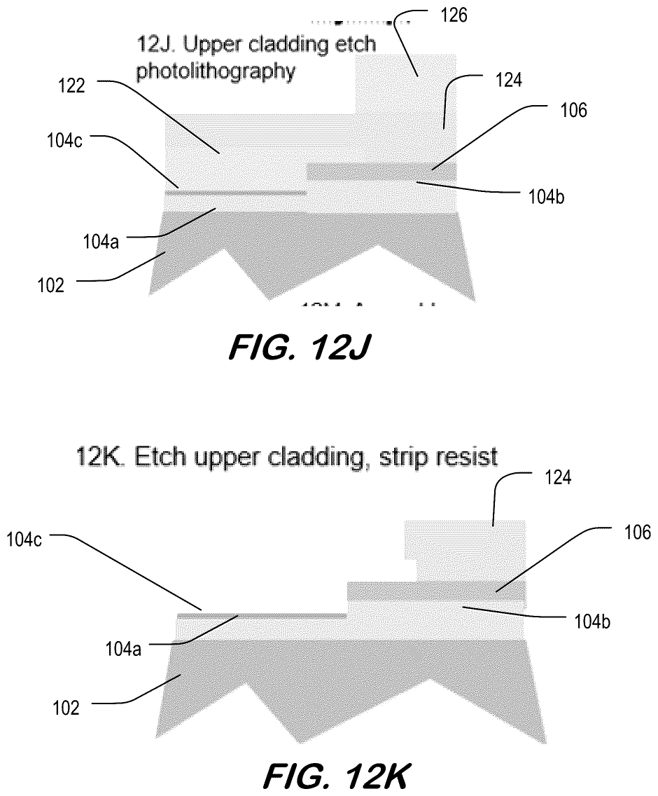

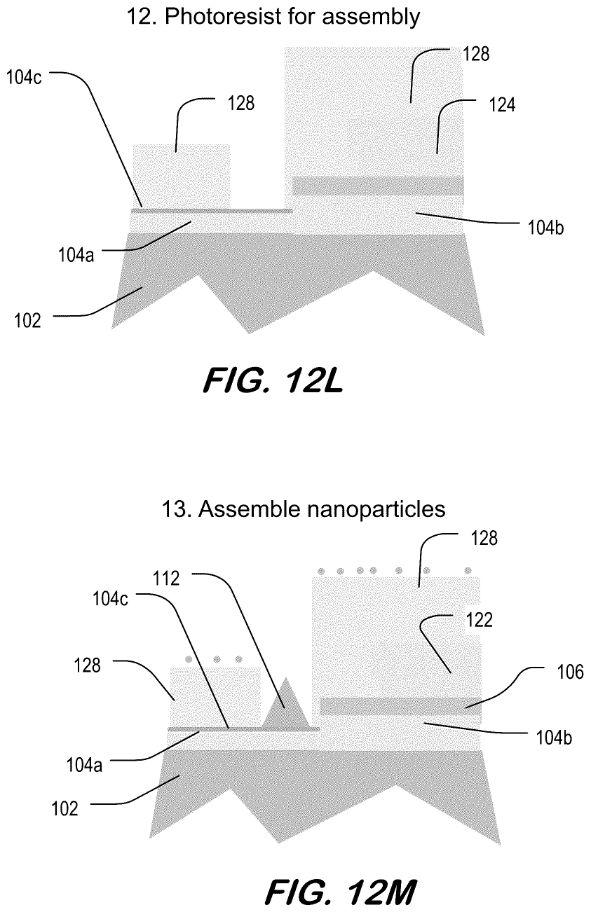

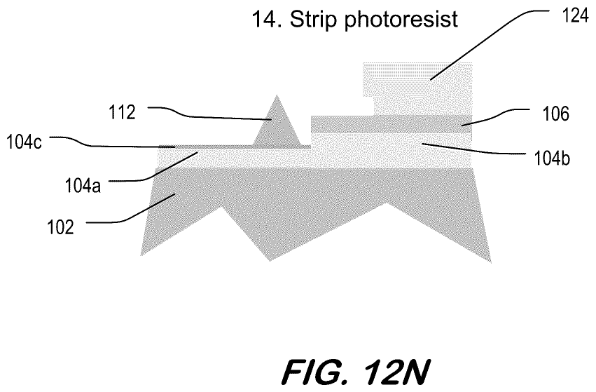

FIGS. 12A-N illustrate side views of a process for assembly of the photonic integrated circuit device 100. As evident by the figures, the process includes various layers and growth of the nanoparticle structure 112. The process may begin with a substrate 102 and oxide 104, as shown in FIG. 12A. Lithography may be used to pattern the oxide layer 106, as shown in FIG. 12B. In one example, an undercut at the edge of the oxide layer 104 is created. The pattern in a photoresist 120 is transferred to the oxide layer 106 using an etch, which may include dry etching, as outlined in FIG. 12C.

In FIG. 12D, an oxide 104 may be added such as a Plasma Enhanced Chemical Vapor Deposited (PECVD) oxide which is grown on both the substrate 102 and the previously-patterned oxide 104 to create a step similar to the first portion 104a and second portion 104b discussed above. At FIG. 12E, photoresist 120 is applied and patterned to allow for deposition of gold 104c in the region where the crystal will be grown. The gold 104c may be patterned using a liftoff process as shown in FIG. 12F. Polymer (such as SU-8) waveguides 106 are patterned on the step or second portion 104b in FIG. 12G.

A polymer coat 122, such as a fluoropolymer (e.g., CYTOP), may be added to the top of the waveguide 106 for mechanical protection and to improve optical performance. The steps to do so may be as follows: Photoresist 120 is patterned to prevent CYTOP adhesion to the end of the waveguide 106 and the gold pad 104c (FIG. 12H). An upper cladding coat 124 is applied as illustrated in FIG. 12I. A further photoresist layer 126 to act as a CYTOP etch mask may be added in FIG. 12J. The CYTOP may then be etched in a plasma etcher, and the photoresist layers removed with acetone, leaving the upper cladding coat 124 patterned on top of the polymer waveguide 106 FIG. 12K. Another photoresist 128 may be patterned in FIG. 12L to guide the growth of the nanoparticles 112 in FIG. 12M. For DNA-assembled structures 112, a silicidation step may be used to solidify the structure, allowing it to be removed from the assembly solution. The DNA nanoparticle arrays may be chemically stabilized prior to removing fluid and prior to removing the photoresist. Finally, in FIG. 12N, the photoresist 128 may be removed and the nanoparticles 112 exposed to form the final structure 112 which can receive the light beams via the waveguides 106.

Accordingly, disclosed herein are processes and system to incorporate self-assembled crystals or mirrors into a waveguide chip process.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method for fabricating a waveguide chip, comprising:
applying at least one higher refractive index material to a portion of a dielectric material, the dielectric material having a first portion and a second portion, the second portion having a higher profile than the first portion and the higher refractive index material being applied to the second portion; and
presenting a light beam via the higher refractive index material to a self-assembled crystal grown on a growth plane on the first portion of the dielectric material via the higher refractive index material arranged above the growth plane on the second portion of the dielectric material.

2. The method of claim 1, further comprising applying photoresists to a portion of the second portion of the dielectric material to facilitate crystal growth on the growth plane, wherein the waveguide is arranged elevated relative to the growth plane.

3. The method of claim 2, further comprising removing the photoresists after completion of crystal grown and prior to use of the waveguide.

4. The method of claim 2, wherein the crystal growth is facilitated via DNA nanoparticle arrays.

5. The method of claim 4, further comprising chemically stabilizing the DNA nanoparticle arrays prior to removing fluid and prior to removing the photoresist.

6. The method of claim 1, wherein the growth plane is spaced a predefined distance relative to the higher refractive index material.

7. The method of claim 1, wherein the growth plane is arranged on the first portion of the dielectric material.

8. The method of claim 1, further comprising applying a growth attachment layer to the first portion of the dielectric material and adjacent to the lower refractive index material to create the growth plane.

9. The method of claim 8, wherein the growth attachment layer is metal.

10. A method for fabricating a waveguide chip, comprising:
applying at least one higher refractive index material to a portion of a dielectric material, the dielectric material having a first portion and a second portion, the second portion having a higher profile than the first portion and the higher refractive index material being applied to the second portion;
applying a growth attachment layer to the first portion of the dielectric material and adjacent to the higher refractive index material to create a growth plane; and
applying photoresists to a portion of the growth attachment layer, dielectric material and higher refractive index material to facilitate crystal growth on the growth plane, the growth plane not including the photoresists, wherein the higher refractive index material is arranged elevated relative to the growth attachment layer and configured to present a light beam to the crystal during use.

11. The method of claim 10, wherein the growth plane is spaced a predefined distance relative to the higher refractive index material.

12. The method of claim 10, further comprising removing the photoresists after completion of crystal grown and prior to use of the waveguide chip.

13. The method of claim 10, wherein the growth attachment layer is gold.

14. A waveguide chip, comprising:
a substrate;
an oxide arranged on the substrate having a first portion adjacent to a second portion, the first portion having a higher profile than the second portion creating an offset between the first portion and the second portion;
a waveguide arranged on the second portion of the oxide; and
a self-assembled crystal structure arranged on the first portion of the oxide configured to receive a beam from the waveguide arranged on the second portion of the oxide.

15. The chip of claim 14, wherein the crystal structure is spaced a predefined distance from the second portion of the oxide.

16. The chip of claim 14, further comprising a growth attachment layer arranged on the first portion of the oxide.

17. The chip of claim 16, wherein the growth attachment layer is metal.

18. The chip of claim 17, wherein the metal is gold.

19. The chip of claim 16, further comprising a photoresist arranged on the growth attachment layer.

20. The chip of claim 14, wherein the crystal structure is facilitated via DNA nanoparticle arrays.
